(19) United States
(12) Patent Application Publication
(10) Pub. No.: US 2025/0339880 A1
(43) Pub. Date: Nov. 6, 2025

(54) METHOD AND DEVICE FOR CLEANING THE SURFACE OF A METAL WIRE OR METAL STRIP

(71) Applicant: Soudronic AG, Bergdietikon (CH)

(72) Inventors: Peter TAIANA, Widen (CH); Ruedi UMBRICHT, Seengen (CH)

(21) Appl. No.: 18/867,479

(22) PCT Filed: Sep. 8, 2022
(86) PCT No.: PCT/EP2022/075011

§ 371 Date: Nov. 20, 2024

(51) Int. Cl. B08B 1/20; B08B 1/16; B08B 1/50; B08B 5/04; B23K 11/06

(52) U.S. Cl. CPC B08B 1/20; B08B 1/165; B08B 1/50; B08B 5/04; B23K 11/061

(57) ABSTRACT

A method for cleaning the surface of a metal wire (2) or a metal strip, in particular of a metal wire (2) or a metal strip used as an intermediate electrode of a roll seam welding machine, wherein the metal wire (2) or the metal strip is guided under tensile stress in the longitudinal direction of the wire or the strip along a plurality of wiping bodies (4) arranged at a distance one behind the other in the longitudinal direction of the wire or the strip, in such a way that the wire or the strip sections (5a-5g) each lying between two successive wiping bodies (4) together form a bow-shaped wire section. It has turned out that this enables an intensive and reliable cleaning with constant cleaning quality.

### CROSS-REFERENCE TO RELATED APPLICATION

This application is a National Stage application of International Patent Application No. PCT/EP2022/075011, filed Sep. 8, 2022, the disclosure of which is incorporated herein by reference in its entirety.

### TECHNICAL FIELD

The invention relates to a method for cleaning the surface of a metal wire or a metal strip, a device for cleaning the surface of a metal wire or a metal strip, and a use of the device according to the preambles of the independent patent claims.

### BACKGROUND OF THE INVENTION

In resistance roll seam welding machines for tinplate packagings such as food cans, a copper wire serves as an intermediate electrode to keep the electrode rolls clean by absorbing and removing the tin released from the tinplate during welding. To ensure good electrical contact between the wire and the electrode roll, it is important that the wire is free from dust and contaminants. For cost reasons, the wire is used twice in such resistance roll seam welding machines, once for the first electrode roll and a second time for the second electrode roll.

Since the wire already has certain impurities, such as copper oxide, in its delivery condition, and copper dust is produced when it is flat-profiled for use as an intermediate electrode, it is advisable to clean the wire before it is used for the first time, and in any case before the second use. This is particularly the case with highly tinned tinplates (5 to 12 g/m2), as it is required for certain vegetable and fruit cans.

According to the state of the art, the wire is pulled between two brush-covered discs and thus cleaned. These discs have an unsatisfactory and inconsistent cleaning effect and they wear quickly. They also have to be cleaned regularly of the copper dust depositing in them. In addition, a cooling of the wire, which would be desirable after flat-profiling or the first use of the wire, respectively, is hardly possible with the brush-covered disks.

A device for cleaning strip-shaped copper wire is known from CH 691 668 A5, in which the wire is guided over a guide roll with a guide groove and the outer surface of the wire is in contact with the cutting edge of a rotating knife disc. This device has the disadvantage that there is only a punctual contact between the wire surface and the cutting edge of the knife disc, which means that a thorough cleaning is not possible from the outset. Another disadvantage is that the material stripped from the wire enters the vicinity of the device in an uncontrolled manner. Yet another disadvantage of this device is that the wire can only be placed on the guide roll after the knife disc has been removed or swiveled away.

### SUMMARY

The object is therefore to provide technical solutions that at least partially avoid the disadvantages of the state of the art.

This object is achieved by the subject-matter of the independent patent claims.

According to these, a first aspect of the invention relates to a method for cleaning the surface of a metal wire or a metal strip. Preferably, the invention relates to a method for cleaning the surface of a metal wire or a metal strip used as an intermediate electrode of a roll seam welding machine.

According to the invention, the metal wire or the metal strip is thereby guided under tensile stress in the longitudinal direction of the wire or the strip along a plurality of wiping bodies arranged one behind the other at a distance in the longitudinal direction of the wire or the strip in such a way that the wire or the strip sections each lying between two successive wiping bodies together form a bow-shaped wire section, in particular in the form of a bow-shaped polygon line.

It has turned out that this enables an intensive and reliable cleaning with constant cleaning quality.

Preferably, the wiping bodies are thereby provided freely accessible on an outer side of a common carrier body, in such a way that the metal wire or the metal strip can be placed on the wiping bodies by hand, and preferably in addition in such a way that no tools are required for this or components have to be moved or dismantled. This enables a simple and uncomplicated handling during maintenance work.

In a preferred variant of the previously described embodiment of the method, a carrier body is used which has an interior space and in which the distances between the wiping bodies form passages via which the interior space is connected to the surroundings of the carrier body. During the guiding of the metal wire or the metal strip along the wiping bodies for the purpose of cleaning the surface of the metal wire or the metal strip, in this method variant the interior space is pressurized with negative pressure, as a result of which the contaminants stripped at the wiping bodies are extracted via the interior space of the carrier body. Accordingly, this variant makes it possible to remove the material stripped from the wire in a controlled manner. The wire is also cooled by the sucked in air stream passing by it.

Thereby, it is advantageous that the passages have a width in the longitudinal direction of the wire or the strip which is at least twice the width of the metal wire or the metal strip. This ensures that sufficiently large inflow openings are formed between the wire and the boundaries of the passages to generate an air flow suitable for removing the material stripped from the wire.

In a further preferred embodiment of the method, as seen in the longitudinal direction of the wire or the strip, guide elements are arranged before and after the wiping bodies arranged at a distance one behind the other, preferably guide pins, by means of which the metal wire or the metal strip is guided transversely to its bearing direction on the wiping bodies in such a way that the metal wire or the metal strip is guided over the wiping bodies without running up in a lateral direction.

In method variants in which a carrier body carrying the wiping bodies is used, it is preferred that the guide elements are provided in the carrier body. This allows them to be easily provided in the immediate vicinity of the wiping bodies.

In yet another preferred embodiment of the method according to the invention, the wiping bodies used are designed in such a way and the metal wire or the metal strip is guided along the wiping bodies in such a way that the metal wire or the metal strip first passes a wiping edge at each wiping body for stripping contaminants from its surface and is then guided along a contact surface of the wiping body for cooling the metal wire or the metal strip by means of the wiping body. In this way, the wire can not only be cleaned while passing along the wiping bodies, but it can also be actively cooled by means of the wiping bodies.

Ceramic wiping bodies or wiping bodies made of hard metal are advantageously used in the method. Such wiping bodies can be procured at low cost, e.g. in the form of cutting inserts for metal cutting, and have a long service life.

The metal wire or the metal strip which is cleaned according to the method of the invention preferably consists of copper or a copper alloy.

In yet another preferred embodiment of the method, in a first step, a substantially round metal wire is flat-profiled so that, viewed in cross-section, it has two parallel flat sides. Directly after the flat-profiling, the wire is then, in a second step, first guided with a first of the two flat sides under tensile stress in the longitudinal direction of the wire or the strip along a plurality of first wiping bodies arranged at a distance one behind the other in the longitudinal direction of the wire or the strip, in such a way that the wire or the strip sections each lying between two successive first wiping bodies together form a bow-shaped wire section, in particular with the shape of a bow-shaped polygon line. Directly thereafter, the wire is guided with the other of the two flat sides under tensile stress in the longitudinal direction of the wire or the strip along a plurality of second wiping bodies arranged at a distance one behind the other in the longitudinal direction of the wire or the strip, in such a way that the wire or the strip sections each lying between two successive second wiping bodies together form a bow-shaped wire section, in particular with the shape of a bow-shaped polygonal line.

This method is particularly suitable for providing and cleaning before use a copper wire to be used as an intermediate electrode for roll seam welding machines.

A second aspect of the invention relates to a device for cleaning the surface of a metal wire or a metal strip, preferably a metal wire or a metal strip used as or to be used as an intermediate electrode of a roll seam welding machine, wherein the cleaning can preferably be carried out according to the method according to the first aspect of the invention.

The device comprises a carrier body with a plurality of wiping bodies, which are arranged one behind the other at a distance such that a metal wire or a metal strip to be cleaned can be guided along the wiping bodies under tensile stress in the longitudinal direction of the wire or the strip, and the wire or the strip sections each lying between two successive wiping bodies together form a bow-shaped wire section, in particular with the shape of a bow-shaped polygon line.

It has turned out that with such a device, an intensive and reliable cleaning with a constant cleaning quality becomes possible.

Preferably, thereby, the wiping bodies are provided freely accessible on an outer side of the common carrier body in such a way that the metal wire or the metal strip can be placed on the wiping bodies by hand, and preferably in addition in such a way that no tools are required for this or components have to be moved or dismantled. This enables simple and uncomplicated handling during maintenance work.

In a preferred variant of the previously described embodiment of the device, the carrier body has an interior space and the distances between the wiping bodies form passages via which the interior space is connected to the surroundings of the carrier body. During the guiding of the metal wire or the metal strip along the wiping bodies for the purpose of cleaning the surface of the metal wire or the metal strip, the interior space can be pressurized with negative pressure so that the contaminants stripped at the wiping bodies can be extracted via the interior space of the carrier body. Accordingly, this variant makes it possible to remove the material stripped from the wire in a controlled manner. The wire can also be cooled by the sucked in air stream passing by it.

In a further preferred embodiment of the device, as seen in the longitudinal direction of the wire or the strip, guide elements, preferably guide pins, are arranged before and after the wiping bodies arranged at a distance one behind the other, by means of which the metal wire or the metal strip can be guided transversely to its bearing direction on the wiping bodies, in particular in such a way that the metal wire or the metal strip is guided essentially centrally over the wiping bodies. In this way, it can be ensured that the wire contacts the wiping bodies at the points provided for this purpose and, in the case of the aforementioned embodiment of the device, it can also be effected that inflow openings of substantially the same width are formed on both sides of the wire in order to generate an air flow which is suitable for removing the material stripped from the wire and for cooling the wire.

Thereby, it is preferred that the guide elements are provided in the carrier body. Thereby they are in an easy manner arranged in the immediate vicinity of the wiping bodies.

In yet another preferred embodiment of the device, the wiping bodies are designed in such a way and the metal wire or the metal strip can be guided along the wiping bodies in such a way that the metal wire or the metal strip first passes a wiping edge at each wiping body for stripping contaminants from its surface and is then guided along a contact surface of the wiping body for cooling the metal wire or the metal strip by means of the wiping body. In this way, the wire can not only be cleaned while passing along the wiping bodies, but it can also be actively cooled by means of the wiping bodies.

The wiping bodies of the device according to the invention are preferably made of hard metal or ceramic. Such wiping bodies can be procured at low costs, e.g. in the form of cutting inserts for metal cutting, and have a long service life.

A third aspect of the invention relates to the use of the device according to the second aspect of the invention for cleaning a metal wire or a metal strip of copper or of a copper alloy. In such uses, the advantages of the invention are particularly apparent.

### BRIEF DESCRIPTION OF THE DRAWINGS

Further advantages and applications of the invention result from the now following description with reference to the figures. Thereby show:

FIG. 1 is a perspective view of a device according to the invention for cleaning the surface of a copper wire;

FIG. 2 is a longitudinal section through the device of FIG. 1;

FIG. 3 shows the detail X from FIG. 2; and

FIG. 4 is a schematic view of a method according to the invention using the device of FIG. 1.

### DESCRIPTION OF THE PREFERRED EMBODIMENTS

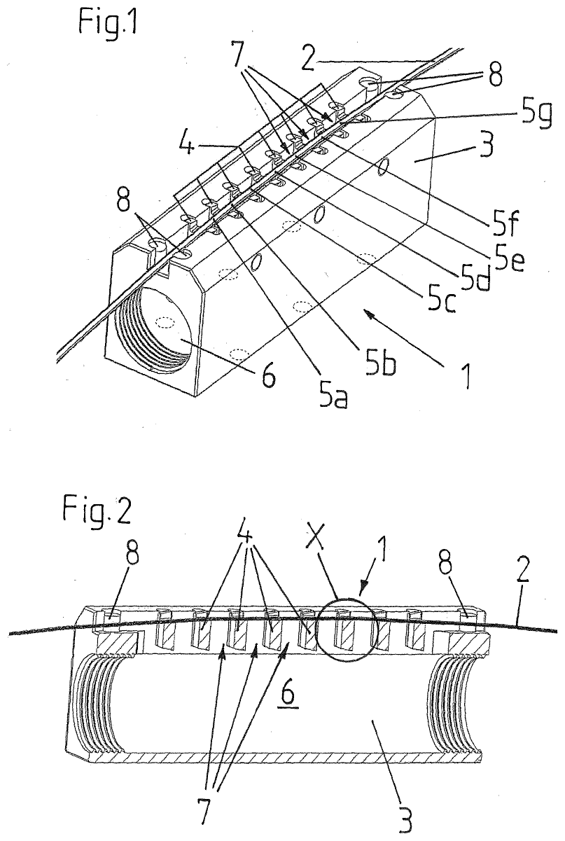

FIG. 1 shows a perspective view of a device 1 according to the invention for cleaning the surface of a metal wire 2 made of copper used as an intermediate electrode of a roll seam welding machine. FIG. 2 shows a longitudinal section through the device of FIG. 1

As can be seen from a synopsis of FIGS. 1 and 2, the device 1 comprises a carrier body 3 made of aluminum or brass with a plurality of wiping bodies 4 made of hard metal, which are arranged one behind the other at a distance in such a way that the copper wire 2 to be cleaned can be guided along the wiping bodies 4 under tensile stress in the longitudinal direction of the wire, and the wire or the strip sections 5a-5g (for reasons of clarity, reference numbers are given only in FIG. 1) each lying between two successive wiping bodies together form a bow-shaped wire section which has the shape of a bow-shaped polygon line.

The wiping bodies 4 are provided freely accessible on an outer side of the carrier body 3, so that the copper wire 2 to be cleaned can be placed on the wiping bodies 4 by hand without using any tools.

The carrier body 3 has an interior space 6 and the distances between the wiping bodies 4 form passages 7 via which the interior space 6 is connected to the surroundings of the carrier body 3. Thereby, as seen in the longitudinal direction of the wire, the passages 7 have a width which corresponds to at least twice the width of the wire 2. The interior space 6 of the carrier body 3 can be pressurized with negative pressure (vacuum) during the guiding of the copper wire 2 along the wiping bodies 4 for the purpose of cleaning the surface of the wire 2, in order to extract the contaminants stripped at the wiping bodies 4 via the interior space 6 of the carrier body 3.

As can be seen further, guide pins 8 are arranged in the carrier body 3 before and behind the wiping bodies 4, which are arranged one behind the other at a distance, as seen in the longitudinal direction of the wire, by means of which the copper wire 2 is guided transversely to its bearing direction on the wiping bodies 4 in such a way that is guided over the wiping bodies 4 without running up in a lateral direction.

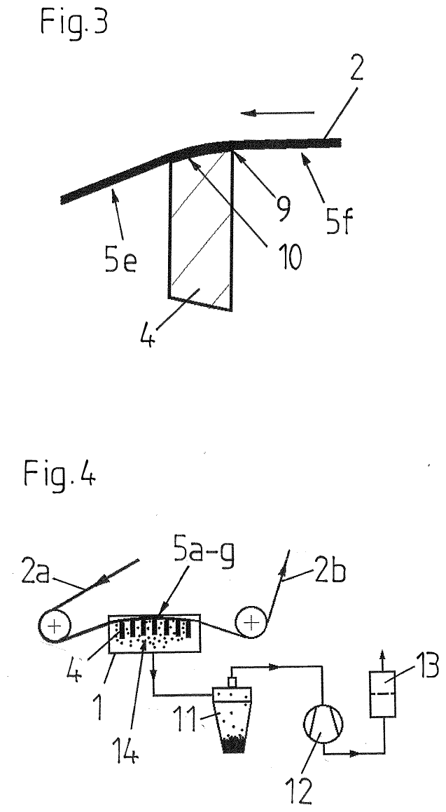

As can be seen in conjunction with FIG. 3, which shows detail X of FIG. 2, the wiping bodies 4 are designed and the copper wire 2 is guided along the wiping bodies 4 in such a way that the wire 2 at each wiping body 4 first passes a wiping edge 9 for stripping contaminants from its surface and is then guided along a contact surface 10 of the wiping body 4 for active cooling of the wire 2 by means of the respective wiping body 4. It should be noted that here the deflection of the wire 2 by the wiping body 4 is shown exaggerated for the purpose of illustrating the described situation.

FIG. 4 shows a schematic view of a method according to the invention using the device of FIG. 1, wherein a copper wire 2a contaminated by its use as an intermediate electrode in the first electrode roll of a roll seam welding machine is cleaned and fed as cleaned copper wire 2b for renewed use as an intermediate electrode in the second electrode roll of the roll seam welding machine.

Thereby, the contaminated copper wire 2a is guided under tensile stress in the longitudinal direction of the wire along the wiping bodies 4 of the device 1 in FIG. 1, which are arranged one behind the other at a distance in the longitudinal direction of the wire, so that the wire sections 5a-5g (see also FIG. 1) each lying between two successive wiping bodies 4 together form a bow-shaped wire section which has the shape of a bow-shaped polygon line.

The thereby stripped contaminants 14 are extracted via the interior space 6 of the carrier body 3 by means of a vacuum pump 12 and are separated in a cyclone 11 before the extracted air is released back into the environment via a filter 13.

While there are described preferred embodiments of the invention in the present application, it should be clearly noted that the invention is not limited to these and that it can be carried out in other ways within the scope of the now following claims.

What is claimed is:

1. A method for cleaning the surface of a metal wire or a metal strip, in particular of a metal wire or a metal strip used as an intermediate electrode of a roll seam welding machine, wherein the metal wire or the metal strip is guided under tensile stress in the longitudinal direction of the wire or the strip along a plurality of wiping bodies arranged at a distance one behind the other in the longitudinal direction of the wire or the strip, in such a way that the wire or the strip sections each lying between two successive wiping bodies together form a bow-shaped wire section.

2. The method according to claim 1, wherein the bow-shaped wire section formed by the wire or the strip sections each lying between two successive wiping bodies is in the form of a bow-shaped polygonal line.

3. The method according to claim 1, wherein the wiping bodies are provided freely accessible on an outer side of a common carrier body in such a way that the metal wire or the metal strip can be placed on the wiping bodies, in particular without tools.

4. The method according to claim 3, wherein the carrier body has an interior space and wherein the distances between the wiping bodies form passages via which the interior space is connected to the surroundings of the carrier body, and wherein, while the metal wire or the metal strip is guided along the wiping bodies for the purpose of cleaning the surface of the metal wire or the metal strip, the interior space is pressurized with negative pressure for the purpose of extracting the contaminants stripped off at the wiping bodies via the interior space of the carrier body.

5. The method according to claim 4, wherein the passages, as viewed in the longitudinal direction of the wire or the strip, have a width which corresponds to at least twice the width of the metal wire or the metal strip.

6. The method according to claim 1, wherein, as viewed in the longitudinal direction of the wire or the strip, guide elements, in particular guide pins, are arranged before and after the wiping bodies arranged at a distance one behind the other, by means of which the metal wire or the metal strip is guided transversely to its bearing direction on the wiping bodies in such a way that the metal wire or the metal strip is guided over the wiping bodies without running up in a lateral direction.

7. The method according to claim 3 and wherein, as viewed in the longitudinal direction of the wire or the strip, guide elements, in particular guide pins, are arranged before and after the wiping bodies arranged at a distance one behind the other, by means of which the metal wire or the metal strip is guided transversely to its bearing direction on the wiping bodies in such a way that the metal wire or the metal strip is guided over the wiping bodies without running up in a lateral direction, wherein the guide elements are provided in the carrier body.

8. The method according to claim 1, wherein the wiping bodies are formed in such a way and wherein the metal wire or the metal strip is guided along the wiping bodies in such a way that the metal wire or the metal strip first passes a wiping edge at each wiping body, for stripping contaminants from its surface, and then is guided along a contact surface of the wiping body for cooling the metal wire or the metal strip by means of the wiping body.

9. The method according to claim 1, wherein ceramic wiping bodies are used or wiping bodies made of hard metal.

10. The method according to claim 1, wherein the metal wire or the metal strip is made of copper or a copper alloy.

11. The method according to claim 1, wherein a substantially round metal wire is flat-profiled such that, as viewed in cross-section, it has two parallel flat sides, and directly after flat-profiling, first with a first of the two flat sides is guided under tensile stress in the longitudinal direction of the wire or the strip along a plurality of first wiping bodies arranged at a distance one behind the other in the longitudinal direction of the wire or the strip in such a way that the wire or the strip sections each lying between two successive first wiping bodies together form a bow-shaped wire section, in particular with the shape of a bow-shaped polygonal line, and directly thereafter with the other of the two flat sides is guided under tensile stress in the longitudinal direction of the wire or the strip along a plurality of second wiping bodies arranged at a distance one behind the other in the longitudinal direction of the wire or the strip in such a way that the wire or the strip sections each lying between two successive second wiping bodies together form a bow-shaped wire section, in particular with the shape of a bow-shaped polygonal line.

12. A device for cleaning the surface of a metal wire or a metal strip, in particular of a metal wire or a metal strip used as an intermediate electrode of a roll seam welding machine, in particular according to claim 1, comprising a carrier body with a plurality of wiping bodies, which are arranged one behind the other at a distance such that a metal wire to be cleaned or a metal strip to be cleaned can be guided under tensile stress in the longitudinal direction of the wire or the strip along the wiping bodies and the wire or the strip sections each lying between two successive wiping bodies thereby together form a bow-shaped strip or wire section.

13. The device according to claim 12, wherein the wiping bodies are arranged one behind the other with a distance such that a metal wire to be cleaned or a metal strip to be cleaned can be guided along the wiping bodies under tensile stress in the longitudinal direction of the wire or the strip, and thereby the bow-shaped wire section formed by the wire or the strip sections each lying between two successive wiping bodies has the shape of a bow-shaped polygon line.

14. The device according to claim 12, wherein the wiping bodies are provided freely accessible on an outer side of the carrier body in such a way that the metal wire to be cleaned or the metal strip to be cleaned can be placed on the wiping bodies, in particular without tools.

15. The device according to claim 14, wherein the carrier body has an interior space and wherein the distances between the wiping bodies form passages via which the interior space is connected to the surroundings of the carrier body, and wherein, while the metal wire or metal strip is guided along the wiping bodies for the purpose of cleaning the surface of the metal wire or the metal strip, the interior space can be pressurized with negative pressure for extracting the contaminants stripped off at the wiping bodies via the interior space of the carrier body.

16. The device according to claim 12, wherein guide elements, in particular guide pins, are arranged before and after the wiping bodies arranged at a distance one behind the other, as seen in the longitudinal direction of the wire or the strip, by means of which the metal wire or the metal strip can be guided transversely to its bearing direction on the wiping bodies, in particular in such a way that the metal wire or the metal strip is guided over the wiping bodies without running up in a lateral direction.

17. The device according to claim 14 and wherein guide elements, in particular guide pins, are arranged before and after the wiping bodies arranged at a distance one behind the other, as seen in the longitudinal direction of the wire or the strip, by means of which the metal wire or the metal strip can be guided transversely to its bearing direction on the wiping bodies, in particular in such a way that the metal wire or the metal strip is guided over the wiping bodies without running up in a lateral direction, wherein the guide elements are provided in the carrier body.

18. The device according to claim 12, wherein the wiping bodies are formed in such a way and wherein the metal wire or the metal strip can be guided along the wiping bodies in such a way that the metal wire or the metal strip first passes a wiping edge at each wiping body, for stripping contaminants from its surface, and then is guided along a contact surface of the wiping body for cooling the metal wire or the metal strip by means of the wiping body.

19. The device according to claim 12, wherein the wiping bodies are made of hard metal or ceramic.

20. A use of the device according to claim 1 for cleaning a metal wire or a metal strip made of copper or a copper alloy.
